(19) United States
(12) Patent Application Publication
(10) Pub. No.: US 2021/0269265 A1
(43) Pub. Date: Sep. 2, 2021

(54) APPARATUS AND METHOD TO RESTORE PAPER STACK INTEGRITY

(71) Applicant: Toshiba TEC Kabushiki Kaisha, Shinagawa-ku (JP)

(72) Inventors: Gary L. NOE, Lexington, KY (US); Michael W. LAWRENCE, Lexington, KY (US); William M. CONNORS, Lexington, KY (US); Zineeddine HAMOUDI, Lexington, KY (US)

(21) Appl. No.: 16/804,247

(22) Filed: Feb. 28, 2020

(51) Int. Cl. B65H 3/06; B65H 3/56; B41J 13/10

(52) U.S. Cl. CPC B65H 3/0661; B65H 2301/4234; B41J 13/103; B65H 3/56

(57) ABSTRACT

A paper feed apparatus. The paper feed apparatus can include a stack of paper, the stack of paper having an uppermost sheet of paper and a second sheet of paper being disposed below the uppermost sheet of paper. A driven pick roller is suitably arranged in contact with the uppermost sheet of paper and is suitably rotatable in a first roller direction to convey the uppermost sheet of paper in a first paper direction. A nip defined by a driven feed roller and a separation roller is suitably disposed downstream from the pick roller, the nip having a gap sufficient for the uppermost sheet of paper to pass through, the gap being sufficient for the separation roller to be in frictional engagement with the second sheet of paper to prevent it from passing through the nip. A rotating element having a plurality of radially extending brush elements is suitably disposed between the driven pick roller and the driven feed roller and rotatable in a second direction opposite the first roller direction to urge the second sheet of paper under the influence of the plurality of radially extending brush elements in a second paper direction opposite the first paper direction.

### TECHNICAL FIELD

This application relates generally to paper feed devices in document processing devices. The application relates more particularly to a paper feed device for facilitating paper stack integrity in a document processing device, such as a copier.

### BACKGROUND

Document processing devices, including printers, copiers, scanners and multifunction peripherals (MFPs) or multifunction devices (MFDs), often utilize a paper feeder. The paper feeder is intended to feed a single sheet of paper from a stack of paper. However, often the paper feeder feeds, or attempts to feed, more than one sheet of paper from the stack of paper.

### BRIEF DESCRIPTION OF THE DRAWINGS

Various embodiments will become better understood with regard to the following description, appended claims and accompanying drawings wherein:

FIG. 1 is an example embodiment of document processing device;

FIG. 2 is a schematic illustration of example components of a paper feeder in a document processing device;

FIG. 3 is an example embodiment of a paper feeder of the present disclosure;

FIG. 4 is an example embodiment of a paper feeder of the present disclosure;

FIG. 5 is an example embodiment of a paper feeder of the present disclosure;

FIG. 6 is an example embodiment of a paper feeder of the present disclosure;

FIG. 7 is an example embodiment of a paper feeder of the present disclosure;

FIG. 8 is an example embodiment of a paper feeder of the present disclosure; and

FIG. 9 is an example embodiment of a paper feeder of the present disclosure.

### DETAILED DESCRIPTION

The apparatuses, systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The apparatuses, systems and methods disclosed herein relate to document processing devices including printers, copiers, scanners and multifunction peripherals (MFPs) or multifunction devices (MFDs) that utilize a drawer, or cassette, that holds a supply of paper, such as a stack of paper. A single sheet of paper is desirably picked off the top of the stack and conveyed into the document processing device. As used herein, MFPs are understood to comprise copiers or printers, alone or in combination with other of the afore-noted functions. It is further understood that any suitable document processing device utilizing a paper feeder is suitably used and can benefit from the disclosure herein.

As noted above, often the paper feeder feeds, or attempts to feed, more than one sheet of paper from the stack of paper. The stack of paper is suitably configured as a plurality of sheets of paper stacked as a block that is each of the plurality of sheets of paper is suitably stacked with edges substantially completely aligned to one another. A sheet of paper that is not so stacked is termed “off-stack” and is problematic when the paper feeder attempts to feed the off-stack sheet. Eliminating multiple paper feeds requires separation of, for example, two sheets that were picked for feeding in the same cycle due to the uppermost sheet of paper being frictionally engaged with an underlying, second sheet of paper. Eliminating multiple paper feeds requires separation of the uppermost sheet of paper from any underlying sheets as well as return of any underlying sheets to the stack of paper. Separation of two sheets is suitably achieved by, for example, paper separation rollers. However, it is beneficial if a separated sheet that is not conveyed into the document processing device not be returned to the stack in an off-stack configuration to ensure the returned sheet is reliably picked up with the next cycle.

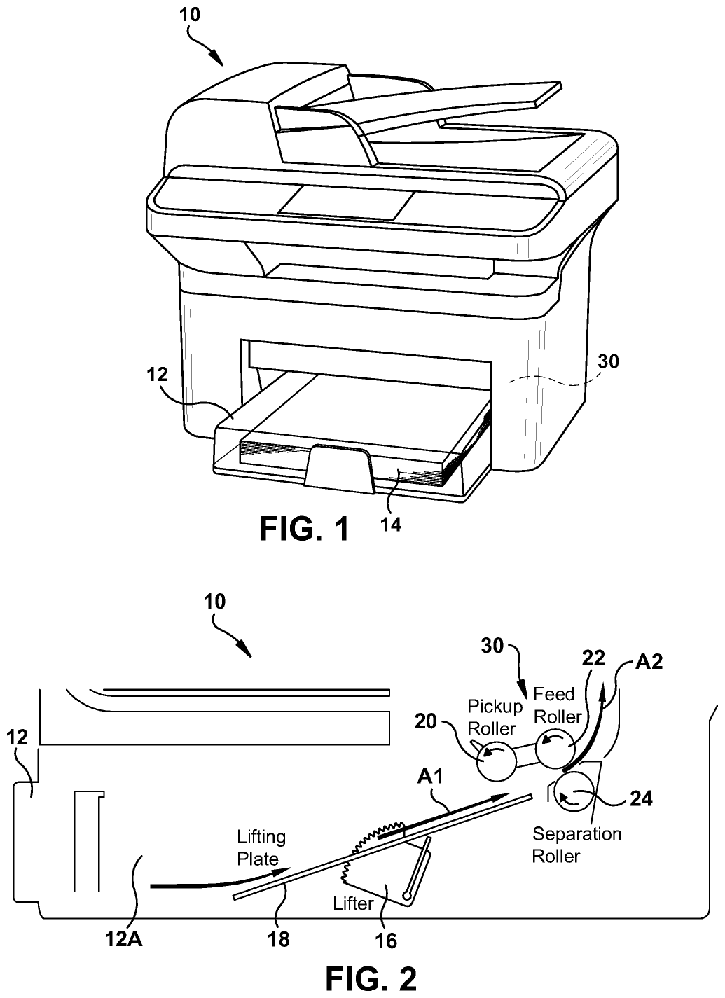

In accordance with the subject application, FIG. 1 illustrates an example embodiment of a document processing device 10 that includes a paper tray 12 in which is resting a stack of paper 14. Internally to the document processing device 10 is a paper feed mechanism 30, an improvement of which is described more fully below. The document processing device 10 is suitably a printer, copier, scanner, multifunction peripheral (MFPs) or a multifunction device (MFDs). In general, any of known document processing device components are suitably used with the example apparatuses, systems, and methods disclosed herein.

Turning now to FIG. 2, illustrated schematically is a portion of a document processing device 10 illustrating the operational environment for paper feed mechanism 30, including example paper feed mechanisms as described herein. Paper tray 12 stores paper (not shown) in an interior paper compartment 12A. A lifter 16 urges a lift plate 18 upwardly such that the leading edge of the uppermost sheet of paper on the stack of paper 14 is urged in compression against a pickup roller 20. The pickup roller 20 rotates to frictionally engage and “pick” the top sheet of paper and move it in a downstream direction, i.e., in the direction of arrow A1, termed a first paper direction. A feed roller 22 in combination with a separation roller 24 separates any sheets pulled with the uppermost sheet of paper. The separation roller 24, which tends to retard paper flow in the downstream direction, second paper direction, turns in a second, opposite direction to that which would cause feeding and is, in example embodiments, suitably operationally associated with the feed roller 22 by a spring loaded slip clutch. The normal force between the feed roller 22 and the separation roller 24 is suitably factory set by a spring (or weight). The normal force setting is suitably factory set so that tangential force at the surface of the feed roller 22 is more than the force needed to slip one sheet of paper over another. Each roller is suitably formed from a cylindrical core supported for rotation on a shaft, which is suitably a fixed shaft. The shaft suitably has flats at each end which allow it to be held in a fixed position. Each roller can suitably include a core, which can suitably include a shaft, and an annular pliable member mounted on the core, the annular pliable member being, or being coated with, an elastomeric surface such as silicone rubber or a like material which provides good frictional contact with the sheets being fed and is impervious to chemicals, such as commonly used silicone release agents.

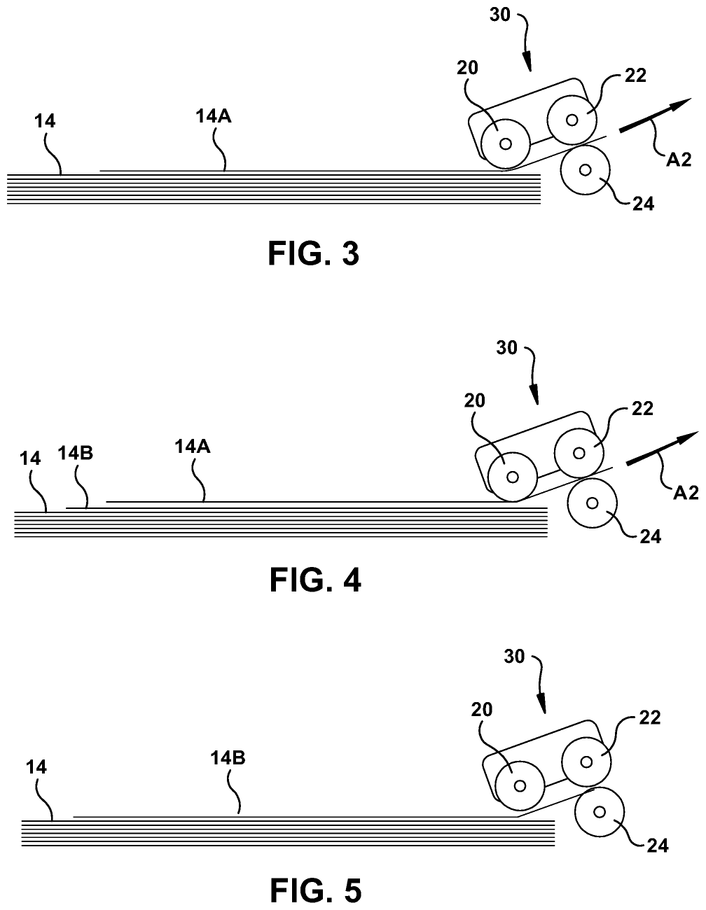

Turning now to FIGS. 3-5, illustrated schematically is further explanation of how a paper feed mechanism 30 works to remove a sheet of paper from a stack of paper 14. The explanation of the various components applies to the paper feed mechanisms disclosed, as will be understood with the disclosure herein. As shown in FIG. 3, the pickup roller 20 is suitably driven in a first direction (in a counter-clockwise rotation as depicted in FIG. 3) and in pressure contact with an uppermost sheet 14A of a stack of paper 14 to draw off the uppermost sheet 14A off the top of the stack of paper 14 and drive it in a first paper direction, also termed the downstream direction. The pickup roller 20 feeds the uppermost sheet 14A to the nip of the feed roller 22 and the separation roller 24, through which it passes downstream in the direction of arrow A2 for processing in the document processing device 10.

Referring now to FIG. 4, in certain instances, in addition to the uppermost sheet 14A of a stack of paper 14, the pickup roller 20 can also draw an additional sheet, such as a second sheet 14B under and in contact with the uppermost sheet 14A. In this situation, the second sheet 14B is suitably separated from the uppermost sheet 14A by the separation roller 24, and only the uppermost sheet 14A passes through the nip of the feed roller 22 and the separation roller 24 for processing in the document processing device 10. The separation roller 24 is suitably a driven or a passive (not driven) roller with a relatively high friction surface to provide a resisting torque to any second sheets 14B pulled through with the uppermost sheet 14A, effectively stopping any further advance of the second sheet 14B of paper. Once separated, the uppermost sheet 14A can continue downstream in the first paper direction, i.e., in the direction of arrow A2, for further processing. However, as depicted in FIG. 5, the second sheet 14B which was stopped can fail to properly return to the top of the stack of paper 14, thereby jeopardizing the picking of it, as now it is the uppermost sheet 14A, but is no longer stacked properly; that is, it is off-stack.

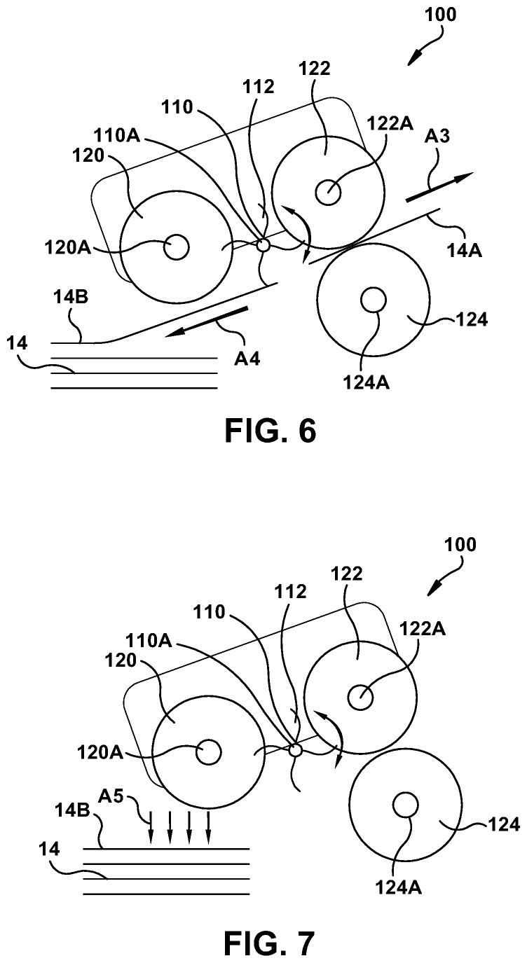

Referring now to FIGS. 6-9, there is shown examples of a paper feed mechanism of the present disclosure that includes structures and features to remedy the situation of a multiple paper feed in which a second sheet of paper fails to return to the paper stack in a way that it is reliably picked in the next cycle.

An example paper feed mechanism 100 is shown in FIGS. 6 and 7. As described above, a pickup roller 120 can rotate in frictional contact with the uppermost sheet 14A of a stack of paper 14 to engage and “pick” the uppermost sheet 14A and move it downstream through the nip of a feed roller 122 and a separation roller 124, through which it passes further in the first paper direction downstream for processing in the document processing device 10, i.e., in the direction of arrow A3. The separation roller 124 separated a second sheet 14B, which has been stopped from entering the nip of the feed roller 122 and the separation roller 124. However, rather than remaining in the position shown in FIG. 6, which corresponds to the position shown in FIG. 5, the second sheet 14B is suitably urged in a second paper direction opposite the first paper direction, i.e., in the direction of the arrow A4, back to the top of the stack of paper 14, as indicated in FIG. 7. A rotating element 110 from which a plurality of flexible, rotating brush elements 112 extend radially, suitably rotates in a second direction (clockwise as indicated in FIGS. 6 and 7) to contact and push the second sheet 14B back in an upstream direction, that is, in the second paper direction indicated by arrow A4. In an embodiment, the rotating brush elements 112 can push the second sheet 14B effectively back to the top of the stack of paper 14, such that it rests, including by gravity as indicated by the arrows A5 properly in place on the stack of paper 14, ready to be picked as the new uppermost sheet of paper in a subsequent pick cycle. The rotating element 110 is suitably disposed, as shown, between the pickup roller 120 and the feed roller 122. In an embodiment, the rotating element 110 suitably runs in a rotating manner continuously as the paper sheets are conveyed by the pickup roller 120 downstream to the nip of the feed roller 122 and the separation roller 124. In an embodiment, the rotating element 110 starts rotating after the trailing edge of the uppermost sheet 14A clears the nip between the feed roller 122 and the separation roller 124. The rotating brush elements 112 can comprise flexible, pliable, rubber-like fingers. In an embodiment, the rotating brush elements 112 are sufficiently flexible such that they do not unduly interfere with the motion of the uppermost sheet 14A as it is fed in the direction of arrow A3.

One or all of the pickup roller 120, the feed roller 122, and the separation roller 124 suitably comprise a core and an annular pliable member mounted on a peripheral surface of the core. The pliable member is suitably made of rubber, elastomer, silicone rubber, or other material having a sufficient coefficient of friction with paper to achieve the respective roller's purpose. It is believed, for example, that the coefficient of friction of rubber-to-paper is in the range of 1 to 2. Each of the rotating elements can rotate about a central axis. In an embodiment, the pickup roller 120 rotates about a first central axis 120A, the feed roller 122 rotates about a second central axis 122A, the separation roller 124 rotates about a third central axis 124A, and the rotating element 110 rotates about a fourth central axis 110A. In an embodiment, at least two of the first central axis 120A, the second central axis 122A, the third central axis 124A, and the fourth central axis 110A are generally parallel.

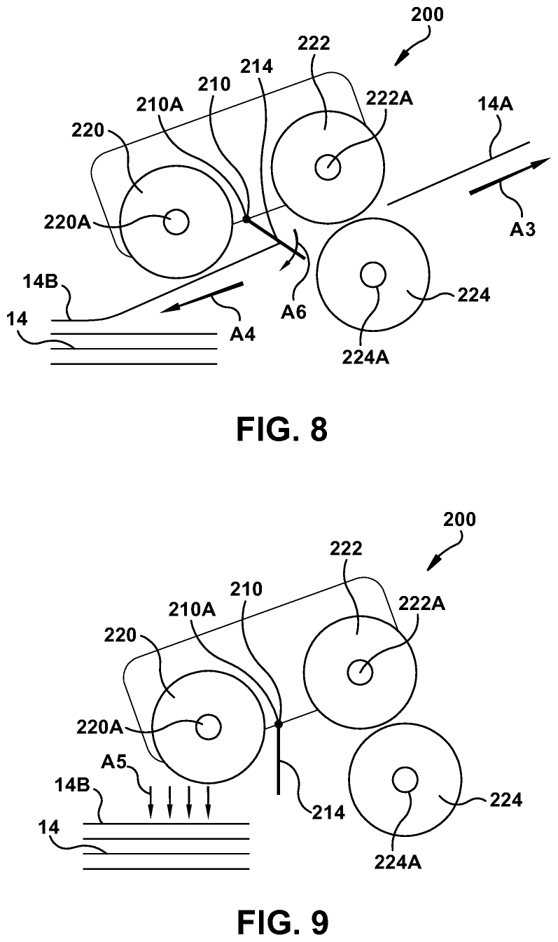

Referring now to FIGS. 8 and 9, as described above, a pickup roller 220 can rotate in frictional contact with the uppermost sheet 14A on a stack of paper 14 to engage and “pick” the uppermost sheet 14A and move it in the first paper direction, that is, downstream through the nip of a feed roller 222 and a separation roller 224, through which it passes for processing in the document processing device 10 in the direction of arrow A3. The separation roller 224 separated a second sheet 14B, which has been stopped from entering the nip of the feed roller 222 and the separation roller 224. However, rather than remaining in the position shown in FIG. 8, which corresponds to the position shown in FIG. 5, the second sheet 14B is suitably urged back upstream, i.e., in the second paper direction as indicated by the arrow A4, back to the top of the stack of paper 14, as indicated in FIG. 9. The second sheet 14B is suitably urged in the direction of the arrow A4, back to the top of the stack of paper 14 by a switch element 210 from which a switch extension 214 extends and can pivot in a direction to contact and push the second sheet 14B back in the direction indicated by arrow A6. In an embodiment, the switch element 210 is suitably spring loaded, such that the switch extension 214 can, under a spring loaded bias achieved by the movement of the uppermost sheet 14A, “snap” back in the direction indicated by arrow A6 after the passage of the trailing edge of the uppermost sheet 14A, effectively “kicking” the second sheet 14B effectively back to the top of the stack of paper 14, such that it rests, including by gravity as indicated by the arrows A5 properly in place on the stack of paper 14, ready to be picked as the new uppermost sheet of paper in a subsequent pick cycle. The switch element 210 is suitably disposed, as shown, between the pickup roller 220 and the feed roller 222. The switch extension 214 can comprise relatively rigid materials, such as relatively rigid plastics sufficient to provide a returning force on the second sheet 14B, and can also comprise relatively flexible, pliable, rubber-like materials. In an embodiment, the switch extension 214 is sufficiently pivotal and the spring biasing force sufficient that the switch extension does not unduly interfere with the motion of the uppermost sheet 14A as it is fed in the first paper direction, i.e., in the direction of arrow A3. The switch element can pivot about a central axis that is suitably a switch element pivot axis, e.g., the fourth central axis 210A, as set forth below. In an embodiment, the pickup roller 220 rotates about a first central axis 220A, the feed roller 222 rotates about a second central axis 222A, the separation roller 224 rotates about a third central axis 224A, and the switch element 210 pivots about a fourth central axis 210A. In an embodiment, at least two of the first central axis 220A, the second central axis 222A, the third central axis 224A, and the fourth central axis 210A are generally parallel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A paper feed apparatus for a stack of paper, the stack of paper having an uppermost sheet of paper and a second sheet of paper being disposed below the uppermost sheet of paper, the paper feed apparatus comprising:
a driven pick roller arranged in contact with the uppermost sheet of paper, and rotatable in a first roller direction to convey the uppermost sheet of paper in a first paper direction;
a nip defined by a driven feed roller and a separation roller, the nip being downstream from the driven pick roller, the nip defining a gap sufficient for the uppermost sheet of paper to pass through, the gap being sufficient for the separation roller to be in frictional engagement with the second sheet of paper to prevent it from passing through the nip; and
a rotating element comprising a plurality of radially extending brush elements disposed between the driven pick roller and the driven feed roller and rotatable in a second direction opposite the first roller direction to urge the second sheet of paper under an influence of the plurality of radially extending brush elements in a second paper direction opposite the first paper direction.

2. A paper feed apparatus according to claim 1, further comprising a paper tray, and the stack of paper is disposed in the paper tray.

3. A paper feed apparatus according to claim 2, wherein the paper tray comprises a lift plate disposed between a bottom surface and the stack of paper.

4. A paper feed apparatus according to claim 1, wherein the stack of paper comprises a plurality of sheets of paper, each of the plurality of sheets of paper being stacked substantially completely aligned on one another.

5. A paper feed apparatus according to claim 1, wherein the driven pick roller rotates about a first central axis and the rotating element rotates about a fourth central axis that is generally parallel to the first central axis.

6. A paper feed apparatus according to claim 1, wherein at least one of the driven pick roller, the driven feed roller and the separation roller comprises a core and an annular pliable member mounted an a peripheral surface of the core.

7. A paper feed apparatus according to claim 6, wherein the annular pliable member comprises a silicone rubber.

8. A paper feed apparatus for a stack of paper, the stack of paper having an uppermost sheet of paper and a second sheet of paper being disposed below the uppermost sheet of paper, the paper feed apparatus comprising:
a driven pick roller arranged in contact with the uppermost sheet of paper, and rotatable in a first roller direction to convey the uppermost sheet of paper in a first paper direction;
a nip defined by a driven feed roller and a separation roller, the nip being downstream from the driven pick roller, the nip defining a gap sufficient for the uppermost sheet of paper to pass through, the gap being sufficient for the separation roller to be in frictional engagement with the second sheet of paper to prevent it from passing through the nip; and
a switch element comprising a pivoting switch extension that is spring-biased by a pivot spring, the switch element being disposed between the driven pick roller and the driven feed roller and the pivoting switch extension pivotable under a force of the pivot spring in a second direction opposite the first paper direction to urge the second sheet of paper under an influence of the pivoting switch extension in a second paper direction opposite the first paper direction.

9. A paper feed apparatus according to claim 8, further comprising a paper tray, and the stack of paper is disposed in the paper tray.

10. A paper feed apparatus according to claim 9, wherein the paper tray comprises a lift plate disposed between a bottom surface of the paper tray and the stack of paper.

11. A paper feed apparatus according to claim 8, wherein the stack of paper comprises a plurality of sheets of paper, each of the plurality of sheets of paper being stacked substantially completely aligned to one another.

12. A paper feed apparatus according to claim 8, wherein the driven pick roller rotates about a first central axis and the switch element pivots about a fourth central axis that is generally parallel to the first central axis.

13. A paper feed apparatus according to claim 8, wherein at least one of the driven pick roller, the driven feed roller and the separation roller comprises a core and an annular pliable member mounted an a peripheral surface of the core.

14. A paper feed apparatus according to claim 13, wherein the annular pliable member comprises a silicone rubber.

15. A method for feeding paper in a document processing device, the method comprising the steps of:
providing a stack of paper, the stack of paper having an uppermost sheet of paper and a second sheet of paper being disposed below the uppermost sheet of paper;
providing a driven pick roller arranged in spaced relationship with a leading edge of the uppermost sheet of paper, the driven pick roller rotating in a first roller direction to drive the uppermost sheet of paper in a first paper direction;
providing a nip defined by a driven feed roller and a separation roller, the nip being downstream in a spaced relationship from the driven pick roller, the nip having a gap sufficient for the uppermost sheet of paper to pass through, the gap being sufficient for the separation roller to be in frictional engagement with the second sheet of paper to prevent it from passing through the nip;
providing a rotating element comprising a plurality of radially extending brush elements disposed between the driven pick roller and the driven feed roller and rotatable in a second roller direction opposite the first roller direction to urge the second sheet of paper under an influence of the plurality of radially extending brush elements in a second paper direction opposite the first paper direction;
urging the stack of paper into contacting relationship with the driven pick roller;
driving the uppermost sheet of paper off the stack of paper in a the first paper direction into the nip by frictional contact between the uppermost sheet of paper and the driven pick roller;
driving the second sheet of paper off the stack of paper in a the first paper direction by frictional contact between the uppermost sheet of paper and the second sheet of paper;
passing the uppermost sheet of paper through the nip; and
driving the second sheet of paper back onto the stack of paper in the second paper direction by frictional contact with the plurality of radially extending brush elements of the rotating element rotating in the second roller direction.

16. A method for feeding paper in a document processing device of claim 15, wherein the driven pick roller rotates about a first central axis and the rotating element rotates about a fourth central axis that is generally parallel to the first central axis.

17. A method for feeding paper in a document processing device of claim 15, wherein at least one of the driven pick roller, the driven feed roller and the separation roller comprises a core and an annular pliable member mounted an a peripheral surface of the core.

18. A method for feeding paper in a document processing device of claim 17, wherein the annular pliable member comprises a silicone rubber.

19. A method for feeding paper in a document processing device of claim 15, further providing a paper tray containing the stack of paper, and wherein the paper tray comprises a lift plate disposed between a bottom surface of the paper tray and the stack of paper.

20. A method for feeding paper in a document processing device of claim 15, wherein the stack of paper comprises a plurality of sheets of paper, each of the plurality of sheets of paper being stacked substantially completely aligned to one another.
